(19) United States
(12) Patent Application Publication
(10) Pub. No.: US 2026/0164512 A1
(43) Pub. Date: Jun. 11, 2026

(54) HEATING SUBSTRATE AND CAMERA MODULE INCLUDING THE SAME

(71) Applicant: Samsung Electro-Mechanics Co., Ltd., Suwon-si (KR)

(72) Inventors: Youngan CHOI, Suwon-si (KR); Solji CHANG, Suwon-si (KR); Hwahyun JEON, Suwon-si (KR)

(73) Assignee: Samsung Electro-Mechanics Co., Ltd., Suwon-si (KR)

(21) Appl. No.: 19/179,029

(22) Filed: Apr. 15, 2025

(30) Foreign Application Priority Data
Oct. 21, 2024 (KR) 10-2024-0143567

(51) Int. Cl. H05B 3/84; G02B 27/00

(52) U.S. Cl. CPC H05B 3/84; G02B 27/0006

(57) ABSTRACT

A heating substrate includes a heating layer; a first insulating layer disposed on a first surface of the heating layer; and a first outer layer, disposed on the first insulating layer, having a roughness greater than a roughness of the first insulating layer.

### CROSS-REFERENCE TO RELATED APPLICATIONS

This application claims the benefit under 35 USC 119(a) of Korean Patent Application No. 10-2024-0143567 filed on Oct. 21, 2024, in the Korean Intellectual Property Office, the entire disclosure of which is incorporated herein by reference for all purposes.

### BACKGROUND

### 1. Field

The present disclosure relates to a heating substrate (or a heating member) and a camera module including the same.

### 2. Description of the Background

Ultra-small cameras are widely used in vehicles, e.g., an ultra-small camera may be adopted in a black box camera for vehicle protection or objective data in a traffic accident, a rear surveillance camera that allows a driver to monitor a blind spot at the rear of the vehicle through a screen to ensure safety when the vehicle is in reverse, a perimeter detection camera capable of monitoring the vehicle's surroundings, or the like.

Because camera modules used in vehicles may be exposed to external temperatures, it may be desirable to remove ice, frost, or the like from the lens using a substrate having a heating function, for example. An insulating material on the surface of the substrate having the heating function may have slippery characteristics, which may present a problem when the substrate is separated from a lens barrel or housing when the substrate is disposed on the camera module for the vehicle.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a heating substrate includes a heating layer; a first insulating layer disposed on a first surface of the heating layer; and a first outer layer, disposed on the first insulating layer, having a roughness greater than a roughness of the first insulating layer.

The heating substrate may further include a second insulating layer disposed on a second surface facing the first surface of the heating layer; and a second outer layer, disposed on the second insulating layer, having a roughness greater than a roughness of the second insulating layer.

The roughness of the first outer layer may have an embossed form.

The heating layer may include a conductive metal material.

The conductive metal material may include any one or any combination of any two or more of steel use stainless (SUS), copper, and aluminum.

The first insulating layer may include polyimide.

In another general aspect, a camera module includes a substrate on which an image sensor is mounted; a connection member connected to the substrate; and a heating substrate, connected to the connection member, configured to transfer heat to a lens barrel. The heating substrate includes a heating layer, a first insulating layer disposed on a first surface of the heating layer, and a first outer layer disposed on the first insulating layer and having a roughness greater than a roughness of the first insulating layer.

The heating substrate may further include a second insulating layer disposed on a second surface facing the first surface of the heating layer, and a second outer layer disposed on the second insulating layer and having a roughness greater than a roughness of the second insulating layer.

The roughness of the first outer layer may have an embossed form.

The heating layer may include a conductive metal material.

The first insulating layer may include polyimide.

The camera module may further include a housing accommodating the substrate, wherein the connection member has a portion in contact with an inner wall of the housing.

Other features and aspects will be apparent from the following detailed description, the drawings, and the claims.

### BRIEF DESCRIPTION OF DRAWINGS

FIG. 1 is a perspective view illustrating an appearance of a camera module according to an embodiment.

FIG. 2 is an exploded perspective view of the camera module according to an embodiment.

FIG. 3 is a cross-sectional view showing a portion of a housing of FIG. 2.

FIG. 4 is a view showing a heating substrate and a connection member of FIG. 3.

FIG. 5 is a view showing an example of a cross-section taken along a line V-V′ of FIG. 4.

FIG. 6 is a view showing another example of the cross-section taken along the line V-V′ of FIG. 4.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Hereinafter, an optical axis may be set as a central axis of a lens perpendicular to a surface of the lens, and a direction of the optical axis may mean a direction parallel to the central axis. In the drawings, the optical axis may be set to a Z-axis, and an X-axis and a Y-axis may be set in a direction perpendicular to the optical axis. In this case, the X-axis and Y-axis may be perpendicular to each other, and an XY plane formed by the X-axis and Y-axis may become a plane perpendicular to the optical axis.

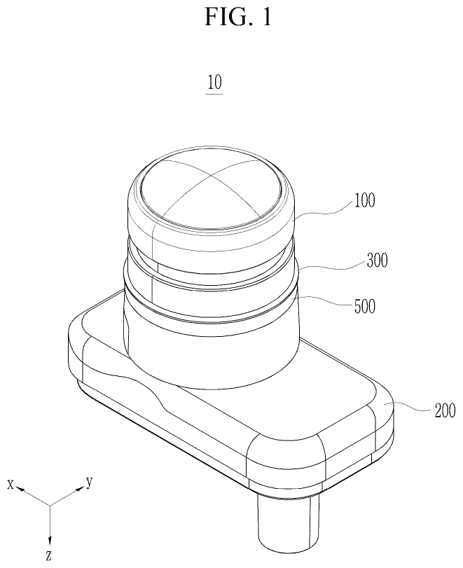

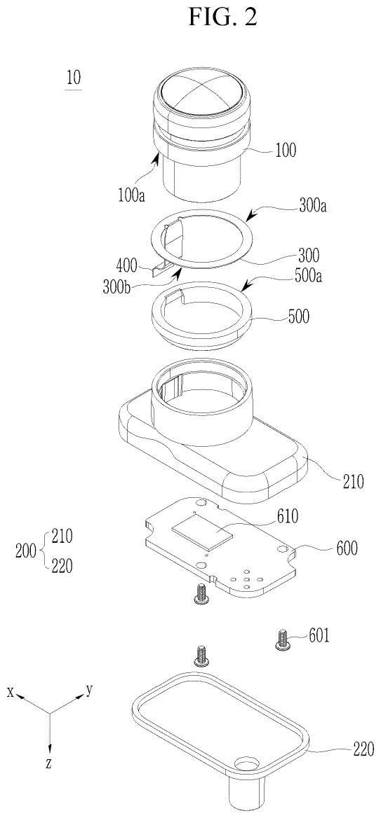

FIG. 1 is a perspective view illustrating an appearance of a camera module according to an embodiment. FIG. 2 is an exploded perspective view of the camera module according to an embodiment.

Referring to FIG. 1 and FIG. 2, the camera module 10 according to the present embodiment may include a lens barrel 100, a housing 200, a heat-insulating member 500, a heating substrate (or a heat-generating substrate) 300, a connection member 400, a substrate 600, and an image sensor 610.

The lens barrel 100 may be disposed at the housing 200. At least a portion of the lens barrel 100 may be accommodated in the housing 200. At least a portion of the lens barrel 100 may be inserted into an opening of the housing 200, and at least a portion of the lens barrel 100 may be disposed above the housing 200.

The diameter of an upper portion of the lens barrel 100 may be different from the diameter of a lower portion of the lens barrel 100. That is, a width measured in the direction perpendicular to the optical axis of the upper portion of the lens barrel 100 may be different from a width measured in the direction perpendicular to the optical axis of the lower portion of the lens barrel 100. The diameter of the upper portion of the lens barrel 100 may be greater than the diameter of the lower portion of the lens barrel 100. A step difference may be formed between the upper portion of the lens barrel 100 and the lower portion of the lens barrel 100, and a first surface 100a that is a surface of the step difference may be disposed between the upper portion of the lens barrel 100 and the lower portion of the lens barrel 100. The first surface 100a may be perpendicular to a direction of the optical axis. The first surface 100a may be supported by the housing 200.

For example, the lens barrel 100 may be screw-coupled to an inner circumferential surface of the housing 200. Screw threads corresponding to each other may be formed on an outer circumferential surface of the lens barrel 100 and the inner circumferential surface of the housing 200.

The lens barrel 100 may include at least one lens. Each lens of the lens barrel 100 may be made of a synthetic resin material, a glass material, a quartz material, or the like. However, the material of the lens is not limited thereto.

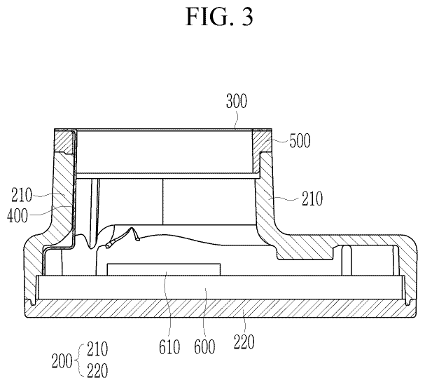

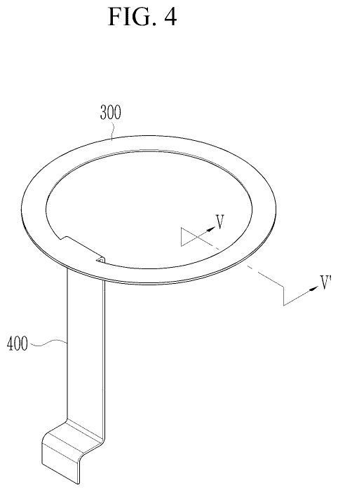

FIG. 3 is a cross-sectional view showing a portion of the housing of FIG. 2. FIG. 4 is a view showing the heating substrate and the connection member of FIG. 3.

Referring to FIG. 2 and FIG. 3, the camera module 10 may include the housing 200. The housing 200 may form an appearance of the camera module 10. The lens barrel 100, the substrate 600, and the connection member 400 may be disposed inside the housing 200. The heat-insulating member 500 may be disposed on the housing 200.

The housing 200 may include an upper housing 210 and a lower housing 220. The upper housing 210 may be disposed on the lower housing 220. An opening may be formed at an upper portion of the upper housing 210. The lens barrel 100 may be inserted through the opening of the upper housing 210. An inner surface of the upper housing 210 may be spaced apart from the lens barrel 100 disposed within the housing 200 by a predetermined distance. At least a portion of the connection member 400 may be disposed at a space between the inner surface of the upper housing 210 and an outer surface of the lens barrel 100.

The lower housing 220 may be disposed below the upper housing 210. The lower housing 220 may be coupled to the upper housing 210. The upper housing 210 may be integrally formed with the lower housing 220.

The heat-insulating member 500 may be disposed on the housing 200. The heating substrate 300 may be disposed on the heat-insulating member 500. The heat-insulating member 500 may prevent heat loss by blocking heat generated from the heating substrate 300 from being transferred to the housing 200. That is, the heat-insulating member 500 may improve a rate at which the heat generated from the heating substrate 300 is transferred to the lens barrel 100.

The heat-insulating member 500 may be disposed along a circumference of at least a portion of the lens barrel 100. The heat-insulating member 500 may be disposed to surround at least a portion of the lens barrel 100. The heat-insulating member 500 may have the shape of a donut having a hollow space. The lens barrel 100 may be inserted into the hollow space. The heat-insulating member 500 may have a shape corresponding to the shape of the heating substrate 300. Accordingly, an area where the heat-insulating member 500 and the heating substrate 300 are in contact may be increased, so that heat generated from the heating substrate 300 is more effectively blocked from being transferred to the housing. However, the shape of the heat-insulating member is not limited thereto, and the heat-insulating member may have any shape corresponding to the heating substrate and into which the lens barrel may be inserted.

The heat-insulating member 500 may have a second surface 500a facing the first surface 100a. The heat-insulating member 500 may have a shape extending in a direction perpendicular to the optical axis from the inserted lens barrel 100. The second surface 500a may be perpendicular to a direction of the optical axis. The second surface 500a may extend in the direction perpendicular to the optical axis.

For example, the heat-insulating member 500 may be formed of a ceramic, a plastic, or a silicon-based material. However, this is an example, and a material of the heat-insulating member 500 may be any material with a low heat transfer coefficient. If the heat-insulating member 500 is formed of the material with the low heat transfer coefficient, heat generated from the heating substrate may be more effectively blocked from being transferred to the housing.

The heating substrate 300 may be disposed on the heat-insulating member 500. The heating substrate 300 may be disposed along a circumference of the lens barrel 100. The heating substrate 300 may be disposed to surround the lens barrel 100. The lens barrel 100, the heating substrate 300, the heat-insulating member 500, and the housing 200 may be sequentially disposed along a direction of the optical axis. The heating substrate 300 may have a ring shape. The lens barrel 100 may be inserted into the heating substrate 300. That is, a hollow space may be formed at the heating substrate 300, and may have a shape extending outward from an outer circumferential surface of the lens barrel 100 inserted into the hollow space. The heating substrate 300 may have a shape corresponding to the shape of the heat-insulating member 500. In FIGS. 1 to 4, the shape of the heating substrate is shown as having a ring shape, but the present disclosure is not limited thereto, and the shape of the heating substrate may be any shape in which an opening is formed so that the lens barrel 100 is inserted.

The substrate 600 may be disposed inside the housing 200. The substrate 600 may be disposed below the lens barrel 100. The substrate 600 may include a printed circuit board (PCB) or a flexible printed circuit board (FPCB). The substrate 600 may be coupled to the connection member 400. The substrate 600 may be electrically connected to the connection member 400.

The substrate 600 may be fixed to the inside of the housing 200 using a fixing member 601. The fixing member 601 may penetrate the substrate 600. For example, the fixing member 601 may have a screw shape.

The image sensor 610 may be disposed inside the housing 200. The image sensor 610 may be mounted on the substrate. The image sensor 610 may be electrically connected to the substrate 600. The image sensor 610 may be disposed on a front surface or an upper surface of the substrate 600. For example, the image sensor 610 may be coupled to the substrate 600 using a surface mounting technology (SMT). As another example, the image sensor 610 may be coupled to the substrate 600 using a flip chip technology. The image sensor 610 may be aligned parallel to the lens barrel 100 in a direction of the optical axis.

Referring to FIG. 3 and FIG. 4, the heating substrate 300 may have a third surface 300a and a fourth surface 300b facing opposite directions with respect to the direction of the optical axis. The third surface 300a may face a surface of a step difference of the lens barrel 100. The third surface 300a may be in contact with the surface of the step difference. The fourth surface 300b may face the second surface 500a of the heat-insulating member 500. The fourth surface 300b may be in contact with an upper surface of the heat-insulating member 500.

The heating substrate 300 may be bonded (or adhered) to one surface of the lens barrel 100 via an adhesive member (not shown). The heating substrate 300 may be bonded to the first surface 100a of the lens barrel 100 via an adhesive member. The third surface 300a of the heating substrate 300 may be bonded to the first surface of the lens barrel 100 via an adhesive member. The heating substrate 300 may be bonded to the heat-insulating member 500 via an adhesive member. The heating substrate 300 may be bonded to the second surface 500a of the heat-insulating member 500 via an adhesive member. The fourth surface 300b of the heating substrate 300 may be bonded to the second surface 500a of the heat-insulating member 500 via an adhesive member.

The heating substrate 300 may have a ring shape. That is, the heating substrate 300 may have an ◯ shape or a donut shape. However, the shape of the heating substrate 300 is not limited to the shape, and the shape of the heating substrate 300 may be any shape in which an opening is formed so that the lens barrel is inserted.

The connection member 400 may be electrically connected to the heating substrate 300. The connection member 400 may be coupled to the substrate 600. The connection member 400 may be electrically connected to the substrate 600. The connection member 400 may be connected to a power source disposed on the substrate 600. The connection member 400 may electrically connect the heating substrate 300 to the substrate 600.

The connection member 400 may be connected to the heating substrate 300 from the inside of the heating substrate 300. The connection member 400 may be connected to the heating substrate 300 through a portion of the heating substrate 300 in which a hollow space is formed. The connection member 400 may have a portion extending along the direction of the optical axis from the heating substrate 300. The connection member 400 may have a portion disposed at an internal space of the heat-insulating member 500. The connection member 400 may have a portion disposed at an internal space of the housing 200. The connection member 400 may extend from the heating substrate 300 toward the substrate 600 along the internal space of the heat-insulating member 500 and the internal space of the housing 200. The connection member 400 may be connected to an edge portion of the substrate 600. The connection member 400 may have a shape in which at least a portion thereof is bent. The shape in which the connection member 400 is bent may correspond to the shape of the housing 200.

The camera module 10 may include a connector (not shown). The connector may be disposed at the housing 200. The connector may be coupled to the substrate 600. The connector may be electrically connected to the substrate 600. The connector may supply external electric power to the camera module 10.

In FIGS. 1 to 3, the heating substrate 300 and the heat-insulating member are shown as being disposed outside the housing 200, but the present disclosure is not limited thereto. It is also possible for the heating substrate 300 and the heat-insulating member to be disposed inside the housing 200. For example, the heat-insulating member may be inserted into the housing 200 through an opening of the housing 200 to be disposed inside the housing 200. The heating substrate 300 may be inserted into the housing 200 through an opening of the housing 200 to be disposed inside the housing 200. The heating substrate 300 may be disposed on the second surface 500a of the heat-insulating member 500 disposed inside the housing 200.

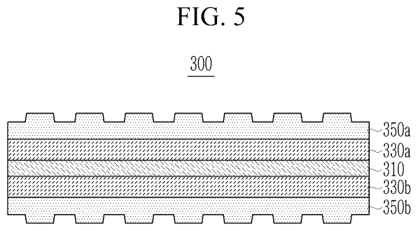

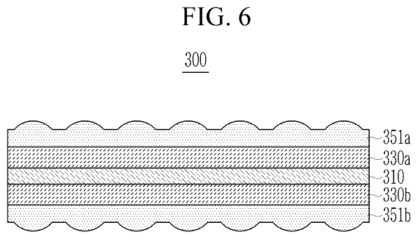

FIG. 5 is a view showing an example of a cross-section taken along a line V-V′ of FIG. 4. FIG. 6 is a view showing another example of the cross-section taken along the line V-V′ of FIG. 4.

Referring to FIG. 5 and FIG. 6, the heating substrate 300 may include a heating layer 310, a first insulating layer 330a, a second insulating layer 330b, a first outer layer 350a, and a second outer layer 350b.

The heating layer 310 may receive an electric current from the substrate 600 to dissipate heat. The heating layer 310 may be electrically connected to the connection member 400. The heating layer 310 may receive an electric current from the substrate 600 through the connection member 400. The heating layer 310 may convert the received current into heat energy. The heating layer 310 may directly generate heat using an electric current to discharge the heat to the surroundings. The heating layer 310 may include a conductive metal material. For example, the heating layer 310 may include at least one of steel use stainless (SUS), copper (Cu), and aluminum (Al). However, the material of the heating layer 310 is not limited thereto, and the material of the heating layer 310 may be any material that generates heat as an electric current is supplied.

The first insulating layer 330a and the second insulating layer 330b may be each disposed on one surface and the other surface of the heating layer 310. That is, the heating layer 310 may have a first surface and a second surface facing each other, the first insulating layer 330a may be disposed on the first surface of the heating layer 310, and the second insulating layer 330b may be disposed on the second surface of the heating layer 310. The first insulating layer 330a and the second insulating layer 330b may block an electric current introduced into the heating layer 310 from flowing to the outside. Each of the first insulating layer 330a and the second insulating layer 330b may include an insulating material. Each of the first insulating layer 330a and the second insulating layer 330b may include a thermosetting resin such as an epoxy resin or polyimide. Additionally, each of the first insulating layer 330a and the second insulating layer 330b may include a thermoplastic resin such as polyethylene (PE), polycarbonate (PC), or polyvinyl chloride (PVC). Heat energy generated in the heating layer 310 may be emitted through the first insulating layer 330a and the second insulating layer 330b, and the electric current introduced into the heating layer 310 may be blocked by the first insulating layer 330a and the second insulating layer 330b. Each of the first insulating layer 330a and the second insulating layer 330b may have a smooth surface.

The first outer layer 350a may be disposed on the first insulating layer 330a, and the second outer layer 350b may be disposed on the second insulating layer 330b. The first outer layer 350a and the second outer layer 350b may have higher roughnesses than those of the first insulating layer 330a and the second insulating layer 330b, respectively. A surface of the first outer layer 350a may be a portion attached to the lens barrel 100 via an adhesive. Because the first outer layer 350a having a higher roughness than the roughness of the first insulating layer 330a is disposed on the first insulating layer 330a, a coupling force between the heating substrate 300 and the lens barrel 100 may be improved. A surface of the second outer layer 350b may be a portion attached to the second surface 500a of the heat-insulating member 500 using an adhesive. Because the second outer layer 350b having a higher roughness than the roughness of the second insulating layer 330b is disposed below the second insulating layer 330b, a coupling force between the heating substrate 300 and the heat-insulating member 500 may be improved. The fact that each of the first outer layer 350a and the second outer layer 350b has the roughness may mean that each of the first outer layer 350a and the second outer layer 350b has a pattern that convexly protrudes at a predetermined interval.

For example, referring to FIG. 5, a roughness of the first outer layer 350a may mean that a plurality of protrusions are formed on a surface of the first outer layer 350a. The protrusion may have a pillar shape, or may have a shape in which a width thereof gradually increases toward the first insulating layer 330a. A roughness of the second outer layer 350b may mean that a plurality of protrusions is formed on a surface of the second outer layer 350b. The protrusion may have a pillar shape, or may have a shape in which a width thereof gradually increases toward the second insulating layer 330b. The plurality of protrusions may be disposed at regular intervals so that the protrusions are regularly disposed. A plane parallel to a surface of the first insulating layer 330a may be disposed between the protrusions.

As another example, referring to FIG. 6, each of a first outer layer 351a and a second outer layer 351b having a roughness may have an embossed form or shape. That is, the fact that each of the first outer layer 351a and the second outer layer 351b has roughness may mean that an embossing is formed on each of the surfaces of the first outer layer 351a and the second outer layer 351b. The embossing may be a protruding portion that convexly protrudes into a round shape. The embossing may mean that convex round shapes are regularly disposed. The convex round shapes may be continuously disposed without interruption. Alternatively, the convex round shapes may be disposed at regular intervals. In this case, a plane parallel to a surface of the first insulating layer 330a may be disposed between the convex round shapes.

For example, each of the first outer layer 351a and the second outer layer 351b may be formed using urethane or powder paint. The first outer layer 351a may be formed by painting or spraying urethane or powder paint on the first insulating layer 330a and then hardening the painted or sprayed urethane or powder paint with heat. The second outer layer 351b may be formed by painting or spraying urethane or powder paint below the second insulating layer 330b and then hardening the painted or sprayed urethane or powder paint with heat.

The heating substrate may be coupled to the lens barrel to remove ice or frost from the lens. Additionally, the heating substrate may be coupled to the heat-insulating member to increase heat transfer efficiency. A heater PCB used as the heating substrate may have an insulating layer disposed on one or both surfaces of a heating layer. The insulating layer may be made of a material with a low roughness such as polyimide (PI). This may cause a low adhesive force between the lens barrel and the heating substrate and a low adhesive force between the heat-insulating member and the heating substrate.

According to the camera module of the present disclosure, because a layer with a high roughness is additionally stacked on an insulating layer of the heating substrate, the adhesive performance of the heating substrate may be improved. Therefore, a phenomenon in which the lens barrel is detached from the heating substrate or the heat-insulating member due to low adhesive performance may be prevented.

One or more embodiments discloses a heating substrate (or a heating member) capable of preventing a phenomenon in which the heating substrate is separated from a lens barrel or a housing by enhancing an adhesive function, and a camera module including the same.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A heating substrate comprising:
a heating layer;
a first insulating layer disposed on a first surface of the heating layer; and
a first outer layer, disposed on the first insulating layer, having a roughness greater than a roughness of the first insulating layer.

2. The heating substrate of claim 1, further comprising:
a second insulating layer disposed on a second surface facing the first surface of the heating layer; and
a second outer layer, disposed on the second insulating layer, having a roughness greater than a roughness of the second insulating layer.

3. The heating substrate of claim 1, wherein the roughness of the first outer layer has an embossed form.

4. The heating substrate of claim 1, wherein the heating layer comprises a conductive metal material.

5. The heating substrate of claim 4, wherein the conductive metal material comprises any one or any combination of any two or more of steel use stainless (SUS), copper, and aluminum.

6. The heating substrate of claim 1, wherein the first insulating layer comprises polyimide.

7. A camera module comprising:
a substrate on which an image sensor is mounted;
a connection member connected to the substrate; and
a heating substrate, connected to the connection member, configured to transfer heat to a lens barrel,
wherein the heating substrate comprises a heating layer, a first insulating layer disposed on a first surface of the heating layer, and a first outer layer disposed on the first insulating layer and having a roughness greater than a roughness of the first insulating layer.

8. The camera module of claim 7, wherein the heating substrate further comprises a second insulating layer disposed on a second surface facing the first surface of the heating layer, and a second outer layer disposed on the second insulating layer and having a roughness greater than a roughness of the second insulating layer.

9. The camera module of claim 7, wherein the roughness of the first outer layer has an embossed form.

10. The camera module of claim 7, wherein the heating layer comprises a conductive metal material.

11. The camera module of claim 7, wherein the first insulating layer comprises polyimide.

12. The camera module of claim 7, further comprising a housing accommodating the substrate,
wherein the connection member has a portion in contact with an inner wall of the housing.
